(19) United States
(12) Patent Application Publication
(10) Pub. No.: US 2007/0116919 A1
(43) Pub. Date: May 24, 2007

(54) Optical recording medium

(75) Inventors: Po-Fu Yen, Hsinchu Hsien (TW); Jung-Po Chen, Hsinchu (TW); Chih-Yuan Wu, Hsinchu (TW); Tzuan-Ren Jeng, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu Hsien (TW)

(21) Appl. No.: 11/508,903

(22) Filed: Aug. 24, 2006

(30) Foreign Application Priority Data
Nov. 23, 2005 (TW) 094141070

(51) Int. Cl. B32B 3/02

(52) U.S. Cl. 428/64.4

(57) ABSTRACT

The present invention relates to an optical recording medium including a substrate and a recording layer having a bi-metal film layer structure formed on a surface of the substrate. The recording layer includes a first metal recording layer of a Ge metal thin film and a second metal recording layer of an Au metal thin film. The bi-metal film layer structure can be formed by sputtering, which is therefore compatible with a conventional disc process. In the optical recording medium, a write area of the recording layer is heated by laser irradiation to reach an eutectic point and melted to form alloy. A write recording point can be distinguished by telling a difference in reflectance between the alloy area and the non-reacted metal area, and thus may be used in both a low-speed recording and a high-speed recording, and can be used in FVD and blue ray DVD recorder.

### FIELD OF THE INVENTION

The present invention relates to optical recording media, and more specifically, to an optical recording medium having a recording layer with a bi-metal film layer structure.

### BACKGROUND OF THE INVENTION

With the coming of a home digital generation, countries all over the world have scheduled a timeline for fully broadcasting digital TV. Upon entering fully digital generation worldwide, to use a large screen TV with a red laser FVD player, a blue ray player or a blue ray digital recorder having dense recording densities and high resolutions is going to be an inevitable trend. Considering the present 900,000,000 families having televisions in the world, a potential market of FVD recorder, blue ray digital recorder and related products thereof should be really remarkable.

Unlike a conventional video home system (VHS), a digital recorder functions as storing digital TV programs or movie pictures of high resolution and high quality. Except for burning discs on a computer, a user can choose to store digital TV programs or movie pictures of high resolution with the digital recorder.

Among various products and techniques of present recording media, rewritable phase-change discs (DVD products : DVD±RW, DVD-RAM) have been developed techniques and markets in computer-based storing digital data. In the future trend of home digitalization and generation of high speed, blue ray discs are believed to become the best choice of next-generation media for accompanying a digital TV to store digital TV programs. Therefore, demands of high resolution FVD discs and blue ray storing interface should keep increasing.

However, viewing the developing process of disc storing media, write-once CD-R or DVD-R is the storing media of highest quantity and market share either in the generation of CD or DVD. While the high resolution FVD and blue ray discs are becoming the most popular storage products of next-generation, a dye used in write-once blue ray DVD is facing two problems in a future specification of blue ray discs. One of the problems is that the dye must have suitable heat absorbing and releasing rate within the wavelength range of blue ray, and the other is that it is difficult to control a thickness of the dye during a coating process to satisfy the specification of the blue ray discs. Thus, to develop inorganic write-once discs by a sputtering process has become the most popular research interests now.

Mechanisms applied to write-once discs include: deformation, which generates pits on the substrate by absorbing heat and releasing gas, and distinguishes write points by determining the differences of reflectance between the pits and lands; alloying of bi-layer, which sputters two metal film layers and melts the metal film layers by laser heating to form alloy recorded marks, and distinguishes write points by determining the differences of reflectance between the alloy and metal; decomposition, which sputters metal nitrides and decomposes by laser heating, and distinguishes write points by differences of reflectance between before and after the decomposition; oxidization, which sputters metal oxide mixtures and forms an oxide of stable stoichiometry by laser heating, and distinguishes write points by determining the differences of reflectance between before and after forming the oxide of stable stoichiometry; phase change, which sputters amorphous thin films of phase change materials with high melting points and high crystallizing speeds and transforms into crystalloid by laser heating, and distinguishes write points by determining the differences of reflectance between before and after crystallization.

In 1992, Junji Tominaga et al. (TDK corporation) disclosed a new recordable compact disc with inorganic material AgOx, which sputters AgOx/SiO₂/Au on CD-R by reactive sputtering and decomposes AgOx by laser heating to a decomposing temperature of about 160° C. to release oxygen, and forms bubbles on the melted substrate to serve as a recording mechanism. In 1994, Junji Tominaga et al. further investigated the CD-R using AgOx as the recording material and realized that replacing the dielectric layer with SiNO of better thermally conductive property may decrease interferences between adjacent signal tracks. In 2003, Hiroyasu Inoue et al. (TDK corporation) proposed a dual-layer inorganic write-once disc based on Blu-ray Disc Format, which uses Cu and Si thin films as the recording material and heats Cu and Si thin films to melt into CuSi alloy. The recording material is then used in a dual-layer blue ray disc to write data at a rate of 36 Mbps and a rate of 72 Mbps respectively. When each write power is more than 8 mW and 9 mW, a jitter value of less than 8% can be obtained.

Furthermore, Yasuo Hosoda et al. (Pioneer corporation) reported a recording mechanism of high density write-once disks using inorganic recording material in ISOM 2003, wherein BiGeN or SnTiN is used as a recording material. The recording layer is Heated by laser to decompose BiN or SnN, so as to generate a difference in reflectance. A jitter value of less than 6.5% is obtained by using the recording material in a dual-layer blue ray disc. Bing-Mau Chen et al. (Ritek corporation) reported an inorganic write once media in ISOM 2003, wherein an Al thin film and a Si thin film are used as the recording material. The Al thin film and the Si thin film are heated to be melted into an AlSi alloy. Under a testing condition of 2.4×DVD disc, a jitter value is 6.5%. Under a clock frequency of 66 MHz and a spinning speed of 8.25 m/s, a jitter value of the blue ray disc is 5%. In 2003, Sony Corp. reported a recording material of a write-once Blu-ray disc in ODS2003, wherein the recording layer is heated by laser to oxidize a non-stoichiometry mixture of SnOxNy into a stoichiometry mixture of SnOxNy. In addition, Matsushita Corp. reported a Te-O-Pd phase change material to be used as a recording material of a dual-layered 2.6G DVD-R in JJAP 1998, wherein the recording layer is heated by laser to transform the original amorphous recording layer into a crystallized recording point, so as to obtain a jitter value of less than 10% through stack structure balancing the signals of the dual-layer. In 2001, Matsushita Corp. reported a Te-O-Pd phase change material to be used as a recording material of a dual-layered blue ray disc in ODS2001, wherein CNR value of more than 50 dB can be obtained under either specification of NA=0.65 or NA=0.85. In 2003, Matsushita Corp. reported a Te-O-Pd phase change material to be used as a recording material of a dual-layered blue ray disc in ODS2003, wherein under a write condition of 1× blue ray disc, a jitter of a first layer and a jitter of a second layer are 5.6% and 5.7% respectively.

However, a Ge metal and an Au metal is never used as a metal recording layer of a bi-metal film layer structure.

### SUMMARY OF THE INVENTION

A purpose of the present invention is to provide an optical recording medium having recording layers of inorganic materials and compatible with existing disc process.

Another purpose of the present invention is to provide an optical recording medium with a simple stack structure, easy to be manufactured, and low costs.

Yet another purpose of the present invention is to provide an optical recoding medium with high storage density, high resolution, and high quality.

Another purpose of the present invention is to provide an optical recording medium able to be used in both a low-speed recording and a high-speed recording.

Another purpose of the present invention is to provide an optical recording medium able to be used in a FVD and a blue ray digital recorder.

To achieve the above purposes and other purposes, the present invention provides an optical recording medium comprising a substrate and a recording layer having a bi-metal film layer structure formed on a surface of the substrate, wherein the recording layer includes a first metal recoding layer composed of a Ge metal thin film, and a second metal recoding layer composed of an Au metal thin film; and wherein a write area formed by the first metal recording layer and the second metal recording layer is heated to reach an eutectic point of the bi-metal to form an alloy, so as to distinguish a write recording point by telling a difference in reflectance between the alloy area and a non-reacted smooth metal area. In accordance with the optical recording medium of the present invention, an recording layer having a bi-metal film layer structure can be formed by sputtering, which is thus compatible with an existing disc manufacturing process, and has advantages of having a simple stack structure, an easy manufacturing process, and low costs. Furthermore, in the optical recording medium, the write area formed by the bi-metal film layer structure of a Ge metal thin film and an Au metal thin film is heated by laser irradiation to reach an eutectic point of Ge and Au to form an alloy, so as to distinguish a write recording point by telling a difference in reflectance between the alloy area and a non-reacted smooth metal area. Therefore, the optical recording medium of the present invention is characterized in having high storage density, high resolution, and high quality, complying with the requirements of both red (650 nm) and blue (405 nm) laser DVD, and capable of performing with a low-speed recording or a high-speed recording.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a diagram illustrating the structure of the optical recording medium in accordance with the first embodiment of the present invention;

FIG. 2 is a diagram illustrating the structure of the optical recording medium in accordance with the second embodiment of the present invention;

FIG. 3 is a diagram illustrating the structure of the optical recording medium in accordance with the third embodiment of the present invention;

FIG. 4 is a diagram illustrating the structure of the optical recording medium in accordance with the fourth embodiment of the present invention;

FIG. 5 is a diagram showing the resistivityρ of the Ge metal thin film, Au metal thin film, and the Ge/Au bi-metal thin film obtained by measuring the inorganic write-once disc having a bi-metal film layer structure of the present invention under different temperature conditions;

FIG. 6 is a diagram showing the difference in reflectance between before a write operation and after a write operation obtained by measuring the inorganic write-once disc having a bi-metal film layer structure of the present invention under different wavelength conditions of performing a write operation;

### DETAILED DESCRIPTION OF THE PREFERRED EMBODIMENTS

The examples of the present invention are illustrated with the following specific embodiments, and a person skilled in the art can easily realize the advantages and effectiveness of the present invention according to the disclosed contents in the specification. The present invention may be executed or applied with other different embodiments, and any details in the specification may be modified or varied based on different points of view and applications without departing from the spirit of the present invention.

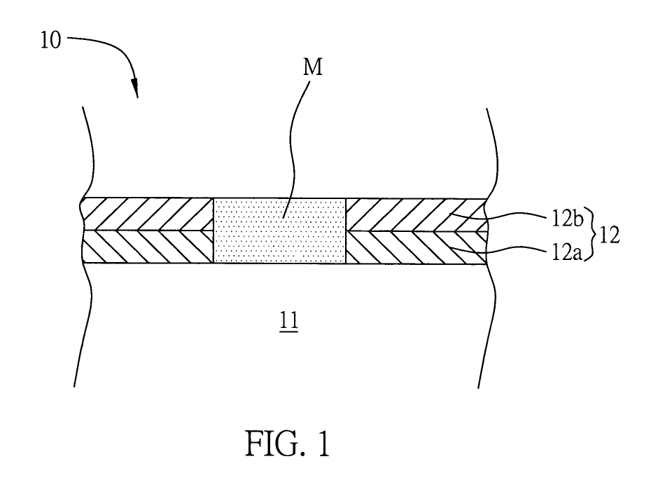

As shown in FIG. 1, an embodiment of an optical recording medium 10 of the present invention comprises a substrate 11 and a recording layer 12 having a bi-metal film layer structure and formed on a surface of the substrate 11 by sputtering. The recording layer 12 includes a second metal recording layer 12b composed of an Au metal thin film, and a first metal recording layer 12a composed of a Ge metal thin film formed between the substrate 11 and the second metal recording layer 12b of the Au metal thin film. The Ge metal thin film and the Au metal thin film, which serve as the first metal recording layer 12a and the second metal recording layer 12b respectively, have a thickness ranging from 5 to 20 nm, and preferably have a thickness ranging from 6 to 12 nm.

No particular limitation is put on the substrate 11 of the optical recording medium 10, as long as the substrate 11 is fabricated robust enough to support the optical recording medium 10. According to the embodiment, the substrate 11 is made of, but not limited to, glass, ceramics, and resin such as polycarbonate resin, acrylic resin, epoxy resin, polystyrene resin, polyethylene resin, polypropylene resin, silicone resin, fluo-polymer, acrylonitrile butadiene styrene resin, polyurethane resin, and the like. Preferably, the substrate 11 is between 0.05 mm to 1.2 mm in thickness.

During performing a write recording operation by using the optical recording medium of the present invention, the write area of the recording layer of the recording medium can be heated by layer irradiation. When a heating temperature thereof reaches an eutectic point of the bi-metal, an interface between the first metal recording layer composed of a Ge metal thin film and the second metal recording layer composed of an Au metal thin film will be melted to form an alloy, and become a recorded mark M of a write area. A resistivity of the bi-metal film layer structure of the recording layer 12 will be dramatically increased from 62 μ-cm to approximately 10,000 μ-cm when the alloy is formed. Therefore, it is able to distinguish the remarked point of a write recording operation by telling a difference in reflectance between the alloy area and a non-reacted smooth metal area.

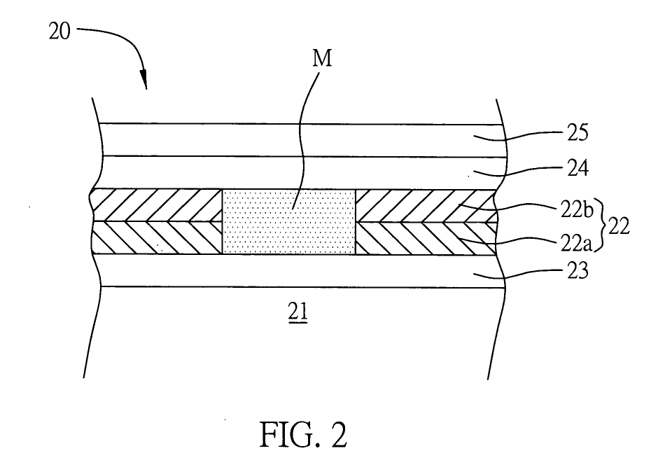

In a second embodiment of the present invention, as shown in FIG. 2, an optical recording medium 20 includes a substrate 21, a first dielectric layer 23 formed on a surface of the substrate 21, a recording layer 22 having a bi-metal film layer structure and formed on the first dielectric layer 23, a second dielectric layer 24 formed on the recording layer 22, and a reflective layer 25 formed on the second dielectric layer 24. The recording layer 22 includes a Ge metal thin film 22a formed on the first dielectric layer 23 to serve as a first metal recording layer, and an Au metal thin film 22b formed on the first metal recording layer to serve as a second metal recording layer.

According to the second embodiment, the first dielectric layer 23, and the second dielectric layer 24 as well, is made of, but is not limited to a mixture of ZnS and SiO₂, or a nitride, an oxide, or an oxynitride of Ge, GeCr, Al, or Si. Preferably, each of the dielectric layers 23 and 24 is between 5 nm to 100nm in thickness. If the thickness of each of the dielectric layers 23 and 24 is less than 5 nm, none of the dielectric layers 23 and 24 can be serves as a protection layer of the metal thin films of the recording layer 22, and is easily cracked during a manufacturing process. On the other hand, if the thickness of both of the dielectric layers 23 and 24 is more than 70 nm, the processing time of forming the dielectric layer needs to be increased, such that decreases the production throughput of the optical recording medium. Furthermore, too thick the dielectric layers 23 and 24 increase a risk of generating cracks in the metal thin films of the recording layer can also be increased by the internal stress.

According to the second embodiment, the reflective layer 25 is made of, but not limited to, Ag, Al, Au, Cu, or an alloy thereof. Preferably, the thickness of the reflective layer 25 is smaller than 200 nm. If the thickness of the reflective layer 25 is larger than 200 nm, the processing time of forming the reflective layer needs to be increased, such that decreases the production throughput of the optical recording medium. In addition, if the thickness of the reflective layer is too thick, a risk of generating cracks in the reflective layer can also be increased by the internal stress.

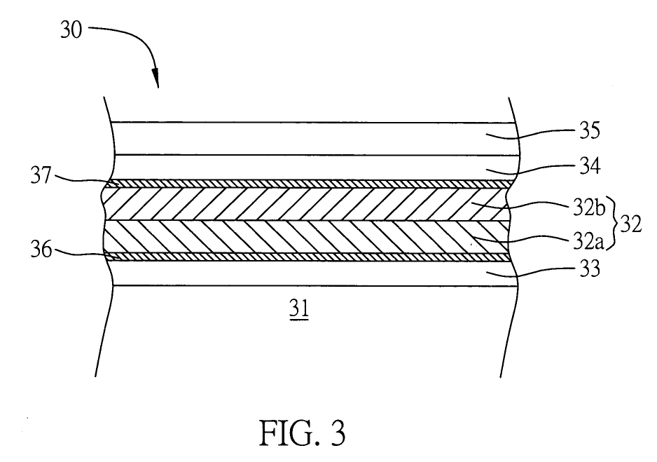

In a third embodiment of the present invention, as shown in FIG. 3, an optical recording medium 30 includes a substrate 31, a dielectric layer 33 formed on a surface of the substrate 31, a first interface layer 36 formed on the first dielectric layer 33, a recording layer 32 having a bi-metal film layer structure formed on the first interface layer 36, a second interface layer 37 formed on the recording layer 32, a second dielectric layer 34 formed on the second interface layer 37, and a reflective layer 35 formed on the second dielectric layer 34. The recording layer 32 includes a Ge metal thin film 32a formed on the first dielectric layer 33 to serve as a first metal recording layer, and an Au metal thin film 32b formed on the first metal recording layer to serve as a second metal recording layer. The thickness and material of each interface layer are not limited, and examples include, without limitation, the following: a nitride, an oxide, or an oxynitride of Ge, GeCr, Al, or Si.

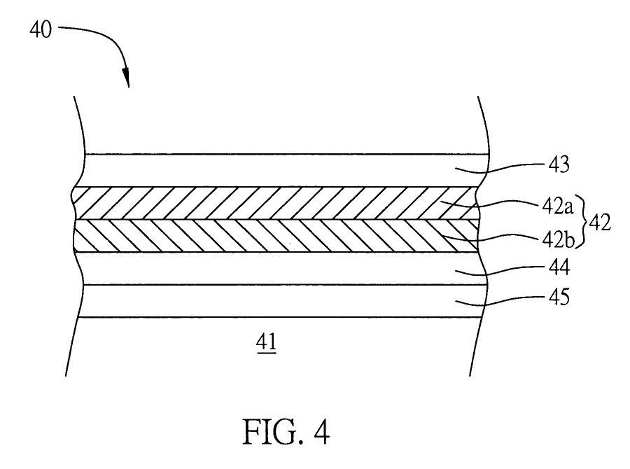

The optical recording medium of the present invention can also have a reversed sputtering stack structure. As shown in FIG. 4, an optical recording medium 40 of a fourth embodiment of the present invention includes a substrate 41, a reflective layer 45 formed on a surface of the substrate 41, a second dielectric layer 44 formed on the reflective layer 45, a recording layer 42 having a bi-metal film layer structure formed on the second dielectric layer 44, and a first dielectric layer 43 formed on the recording layer 42. The recording layer 42 includes an Au metal thin film 42b formed on the second dielectric layer 44 to serve as a second metal recording layer, and a Ge metal thin film 42b formed on the second metal recording layer to serve as a first metal recording layer 42a.

The optical recording medium having a recording layer with a bi-metal film layer structure in accordance with the present invention is compatible with any current disc manufacturing process, and thus has advantages of simple stack structure, simplified manufacturing process, and low costs. Furthermore, in the optical recording medium, the write area formed by the bi-metal film layer structure of the Ge metal thin film and the Au metal thin film is heated by laser irradiation to reach an eutectic point of Ge and Au to form an alloy, so as to distinguish a write recording point by telling a difference in refractive index between the alloy area and a non-reacted smooth metal area. Therefore, the optical recording medium of the present invention is characterized in having high storage density, high resolution, and high quality, complying with the requirements of both red and blue ray DVD, and capable of performing with a low-speed recording or a high-speed recording.

Features and effects of the present invention are further illustrated with the following example. However, details of the example are used to illustrate the present invention, and are by no means used to limit the scope of the invention.

### EXAMPLE 1

A 0.6 mm thick substrate made of polycarbonate resin is provided. A 60 nm thick ZnS-SiO₂ first dielectric layer, a 9 nm thick Ge metal thin film, a 7 nm thick Au metal thin film, a 15 nm thick ZnS-SiO₂ second dielectric layer, and a 120 nm thick Ag reflective layer are successively sputtered on a surface of the substrate to form an inorganic write-once disc having a bi-metal film layer structure.

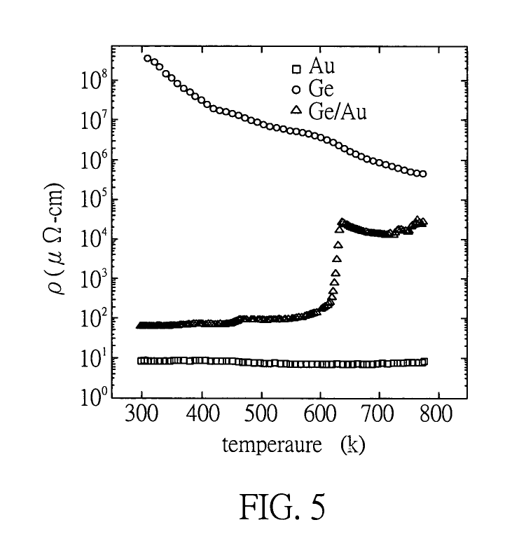

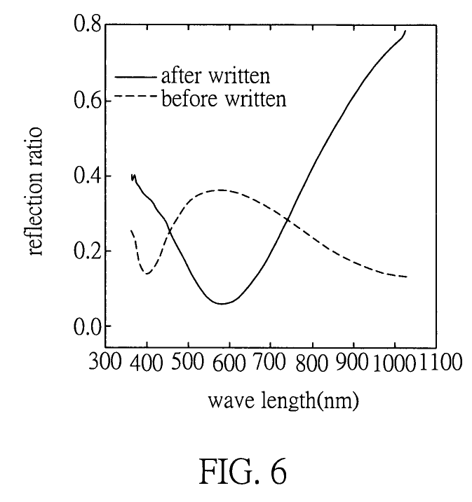

The resistivityρ of the Ge metal thin film, Au metal thin film, and the Ge/Au bi-metal thin film under different temperature conditions ranging from room temperature to 500° C. are measured with a four point measurement metrology (using a high temperature oven, a power supply, a voltmeter, and a temperature controller, and under a temperature increasing rate of 3° C./min). As shown in FIG. 5, an eutectic point of the bi-metal is reached when the temperature is close to 630 K, an interface of the bi-metal will be melted to form an alloy, such that the resistivity is dramatically increases from 62 (μΩ-cm) to approximately 10,000 (μΩ-cm). A surface of the inorganic write-once disc having a bi-metal film layer structure is illuminated with a single point, low power, full range wavelength (350 nm to 1,000 nm) light source to measure the reflectance of the metal before performing a recording operation. The metal layer is then heated by a high power laser to turn the bi-metal into an alloy. The full range wavelength measuring is performed again to measure the reflectance of the metal after performing a recording operation, and a spectrum of a difference in reflectance vs. wavelength is attained. As shown in FIG. 6, the inorganic write-once disc having a bi-metal film layer structure can be used to perform a write operation of both red ray with a wavelength of 650 nm and a blue ray with a wavelength of 405 nm. A modulation of the blue ray is about 0.58, and a modulation of the red ray is about 0.7.

The inorganic write-once disc having a bi-metal film layer structure is measured with a blue ray dynamic testing machine, and the testing conditions are listed in Table. 1.

TABLE 1

| | | |
|---|---|---|
| Capacity | 20 | GB |
| Thickness of substrate | 0.6 | mm |
| Wavelength | 405 | nm |
| N.A. | 0.65 | |
| Modulation code | ETM, RLL(1, 10) | |
| Track pitch | 0.34 | μm |
| Recording format | Land and Groove | |
| Channel clock frequency | 64.8 | MHz |
| Linear velocity | 5.6 | m/s |
| Bit rate | 36.55 | Mbps |

The result of the write test shows a signal-to-noise ratio (PRSNR) of 27.1 dB and an error rate (SbER) of 8×10⁻⁸ in the groove portion; and a signal-to-noise ratio (PRSNR) of 20.9 dB and an error rate (SbER) of 6×10⁻⁶ in the land portion, which are both complying with the specification of a signal-to-noise ratio greater than 15 dB and an error rate less than 5×10⁻⁵.

The above embodiments are merely used to exemplify the theory and utilities of the present invention, and are not used to limit the present invention. A person skilled in the art may modify or vary the above embodiments without departing from the spirit of the present invention. Therefore, the claimed scope of the present invention should be defmed with the following claims.

What is claimed is:

1. An optical recording medium, comprising:
a substrate; and
a recording layer having a bi-metal film layer structure formed on a surface of the substrate, the recording layer comprising a first metal recoding layer composed of a Ge metal thin film, and a second metal recoding layer composed of an Au metal thin film;
wherein a write area formed by the first metal recording layer and the second metal recording layer is heated to reach an eutectic point of the bi-metal to form an alloy, so as to distinguish a write recording point by telling a difference in reflectance between the alloy area and a non-reacted smooth metal area.

2. The optical recording medium of claim 1, wherein the first metal recording layer is formed between the substrate and the second metal recording layer.

3. The optical recording medium of claim 2 further comprising a first dielectric layer formed between the first metal recording layer and the substrate.

4. The optical recording medium of claim 3 further comprising a second dielectric layer formed on the second metal recording layer.

5. The optical recording medium of claim 4, wherein the dielectric layers are made of one selected from the group consisting of a mixture of ZnS and SiO₂, a nitride, an oxide, or an oxynitride of Ge, GeCr, Al, or Si.

6. The optical recording medium of claim 4 further comprising a reflective layer formed on the second dielectric layer.

7. The optical recording medium of claim 6, wherein the reflective layer is made of one selected from the group consisting of Ag, Al, Au, Cu, or an alloy thereof.

8. The optical recording medium of claim 6 further comprising an interface layer formed between the metal layer and the dielectric layers.

9. The optical recording medium of claim 8, wherein the interface layer is made of one selected from the group consisting of a nitride, an oxide, or an oxynitride of Ge, GeCr, Al, or Si.

10. The optical recording medium of claim 1, wherein the second metal recording layer is formed between the substrate and the first metal recording layer.

11. The optical recording medium of claim 10 further comprising a second dielectric layer formed between the second metal recording layer and the substrate.

12. The optical recording medium of claim 11 further comprising a reflective layer formed between the second dielectric layer and the substrate.

13. The optical recording medium of claim 12 further comprising a first dielectric layer formed on the first metal recording layer.

14. The optical recording medium of claim 13 further comprising an interface layer formed between the metal layer and the dielectric layer.

15. The optical recording medium of claim 1, wherein the substrate has a thickness ranging from 0.05 mm to 1.2 mm.

16. The optical recording medium of claim 1, wherein the metal recording layer has a thickness ranging from 5 nm to 20 nm.

17. The optical recording medium of claim 16, wherein the metal recording layer has a thickness ranging from 6 nm to 12 nm.

18. The optical recording medium of claim 1, wherein the write area formed by the first metal recording layer and the second metal recording layer is heated by laser to reach an eutectic point of the bi-metal to form an alloy.

19. The optical recording medium of claim 1, wherein the optical recording medium performs a write recording operation by a red ray with a wavelength of 650 nm.

20. The optical recording medium of claim 1, wherein the optical recording medium performs a write recording operation by a blue ray with a wavelength of 405 nm.
